(19) United States
(12) Patent Application Publication
(10) Pub. No.: US 2016/0318593 A1
(43) Pub. Date: Nov. 3, 2016

(54) A METHOD FOR TREATING BALLAST WATER AND A SYSTEM FOR TREATMENT OF BALLAST WATER IN A SHIP COMPRISING AT LEAST TWO BALLAST TANKS

(71) Applicant: BAWAT A/S, Hørsholm (DK)

(72) Inventor: Jan Stumpe Hummer, Klampenborg (DK)

(21) Appl. No.: 15/109,093

(22) PCT Filed: Jan. 8, 2015
(86) PCT No.: PCT/EP2015/050268

§ 371 Date: Jun. 29, 2016

(30) Foreign Application Priority Data
Jan. 9, 2014 (DK) PA201470009

(51) Int. Cl. B63J 4/00; C02F 1/02; C02F 1/00; B63B 39/03

(52) U.S. Cl. CPC B63J 4/002; B63B 39/03; C02F 1/02; C02F 1/006; C02F 2103/008

(57) ABSTRACT

Ballast water in a ship is treated in at least two ballast tanks with a system for treatment of ballast water. The ballast tanks are in fluid communication with each other so that ballast water can be pumped to each one of the ballast tanks and so that ballast water can be pumped between the ballast tanks either treated or untreated. Ballast water is pumped onboard such that at least one ballast tank is left empty. Next, ballast water is pumped via the system for treatment of ballast water from one ballast tank with untreated ballast water to an empty ballast tank. Pumping and treatment continue until the ballast tank being pumped from is empty.

### FIELD OF INVENTION

The present invention relates to the treatment of ballast water in a ship and in particular to a method for the treating ballast water by means of a system for treatment of ballast water. More in particular, the present invention relates to a method for treating ballast water by means of said system comprising at least two ballast tanks and wherein said system and said ballast tanks are in fluid communication with each other via a treatment system and that ballast water can be pumped to each one of said ballast tanks and such that ballast water can be pumped between said ballast tanks either treated or untreated, the method comprising the following steps:

### BACKGROUND OF INVENTION

To uphold the stability of a ship independently of it carrying cargo or not, ships are provided with tanks that can be filled or emptied depending on the nature of the cargo. Such tanks are designated ballast tanks, and the water charged into them is designated ballast water.

When an empty ship or a ship partially carrying cargo leaves a port, ballast water has been charged into the ballast tanks to uphold the stability and to adjust the buoyancy of the ship.

Almost always, such ballast water will contain live organisms. When the ships arrive at their destinations, and when the ships are once again to take on a cargo, the ballast water is let out in the sea again. This discharge of ballast water may thus potentially introduce invasive species to the marine environment in the destination port, which means that the live organisms are moved from their natural habitat to a new biosphere.

Several techniques and systems have been developed to encounter the above described problem by means of treatment systems which kill organisms in the ballast water.

US 20030205 discloses a synergistic approach to the treatment of ship's ballast water in order to kill harmful marine organisms. Synergism is derived by (i) maintaining the ullage spaces of the ballast tanks at a pressure less than atmosphere—called an “underpressurized” condition—simultaneously that (ii) the ullage space gases are inerted, meaning that at least at one time and preferably for the substantial duration of a ship's voyage, the percentage oxygen in the ullage space gases is reduced below normal atmospheric percentage, and below a level that will, ultimately, sustain aerobic life, including (by gaseous exchange occurring with the inerted ullage gases) aerobic marine life within the ballast water.

WO12116704 discloses a system for treating ballast water in ballast tanks onboard vessels and offshore constructions, said system comprising: one or more ballast tanks, a circulation pump capable of circulating or recirculating, via tubing, ballast water from and to the one or more ballast tanks; a gas supply unit connected to the tubing to the effect that gas, such as atmospheric air and/or inert gas, such as nitrogen and carbon dioxide, can be supplied to the ballast water; and one or more nozzle heads that are functionally connected to the tubing and is/are arranged in one or more ballast tanks, said one or more nozzle heads comprising at least one nozzle for injection of the gas-containing water into the one or more ballast tanks; a device configured for removing and/or killing live organisms present in the ballast water.

A problem associated with the above presented technologies is efficiency and it is an object of the present invention to provide a more efficient method and a more efficient system as an alternative to the prior art.

### SUMMARY OF INVENTION

This is achieved by a method comprising following steps:

ballast water is pumped such that at least one ballast tank is left empty;

ballast water is pumped via the system for treatment of ballast water from one ballast tank with untreated ballast water to an empty ballast tank;

continued pumping and treatment until the ballast tank being pumped from is empty.

The system for treatment of ballast water may comprise a ballast distribution system and a ballast treatment system.

Said treatment system may form an integrated part of said distribution system or it may be connected in parallel with said distribution system or it may be connected in series with said distribution system.

In one embodiment of the invention, the system for treatment of ballast water comprises at least two ballast tanks. Said ballast tanks may be located at starboard side, at port side, in the stern or the ship, in the bow of the ship or a combination of said locations. Said ballast water tanks may be in mutual fluid communication by means of said distribution system.

Said distribution system may comprise fluid conducts, tubes, strings or like and configured such that fluid may be conducted between any two ballast water tanks and there may be pumps, valves or sub-systems there in between.

The system for treating ballast water may be configured such that ballast water may be distributed between any ballast tanks either treated or untreated. The system for treating ballast water may additionally be configured to distribute ballast water either treated, untreated or a combination of both from more than one ballast tank into a ballast tank which is empty.

The system may also be configured such that ballast water may be distributed from more than one ballast tank to more than one ballast tank either treated or untreated.

By untreated ballast water it is meant such ballast water which has a content which does not comply with the relevant regulations as regards to e.g. bacteria, Phyto plankton or Zooplankton contents exceeding these said levels.

The ballast water is denoted as treated when contents subjected to regulation are under the acceptable level.

Said treatment system may comprise a gas supply unit, a radiation unit, ultrasonic sound, heat treatment system and one or several injection nozzles.

In a preferred embodiment of the invention, the method for treating ballast water comprises the step of charging ballast water into said ballast tanks by means of at least one pump. Said at least one pump may be configured to achieve bi-directional flow. The ballast water may be charged to said ballast tanks via a ballast water inlet which may also function as a ballast water outlet. The ballast water inlet may be in fluid communication with a ballast water supply like the sea or a ballast water supply like a different tank onboard or on land.

In a preferred embodiment of the invention, the ballast water may be charged to the ballast tanks such that one ballast tank is left empty or alternatively, ballast water is charged such that sufficient volume is left empty in said ballast tanks so that ballast water may be distributed among said ballast tanks such that at least one ballast tank become empty. The word empty should here be interpreted as substantially empty or empty to that degree which is achievable by the ballast water distribution system though it may not be possible to empty a ballast tank completely.

Once at least one ballast tank is empty, ballast water may be distributed e.g. by means of at least one pump, from a ballast tank containing e.g. treated or untreated ballast water to said empty tank by means of the ballast distribution system and may be distributed via the treatment system. Said distribution may be carried out e.g. at port or at sea during transit.

The treatment system may comprise one or several injection nozzles installed in one or several of the ballast tanks. Said gas injection nozzles makes possible the treatment of ballast water when said ballast water is inside a ballast tank. It is thereby achieved, that a ballast water tank may be charged with seawater which is subsequently treated by said injection nozzles inside said ballast water tank.

In one embodiment of the invention, the treatment system may comprise at least two treatment valves where each treatment valve is positioned between two ballast tanks, dividing a ballast water conduct in substrings where a number of ballast tanks are connected to each substring. The ballast tanks may be located at starboard or port side or both. If the number of ballast tanks located on e.g. starboard side is uneven and a treatment valve is placed between every two ballast water tanks, then one resulting substring may be connected to one ballast tank less than the other substrings.

Also, the text refers to inert gas; that is not to be construed narrowly, as the phrase “inert gas” as used in this text means that the gas composition can be e.g. nitrogen, carbon dioxide or argon. It could also be some other gas or gas mixture in a ratio and concentration where bubbles from the gasses would be able to wash out so much oxygen from the ballast tanks that organisms present therein are killed. However, in some embodiments gas supply unit could also be a unit supplying atmospheric gas/air.

### BRIEF DESCRIPTION OF DRAWINGS

FIG. 1 illustrates a schematic diagram of a first embodiment of the invention comprising a treatment system.

FIG. 2 illustrates a schematic diagram of a second embodiment of the invention comprising a treatment system.

### DETAILED DESCRIPTION OF DRAWINGS

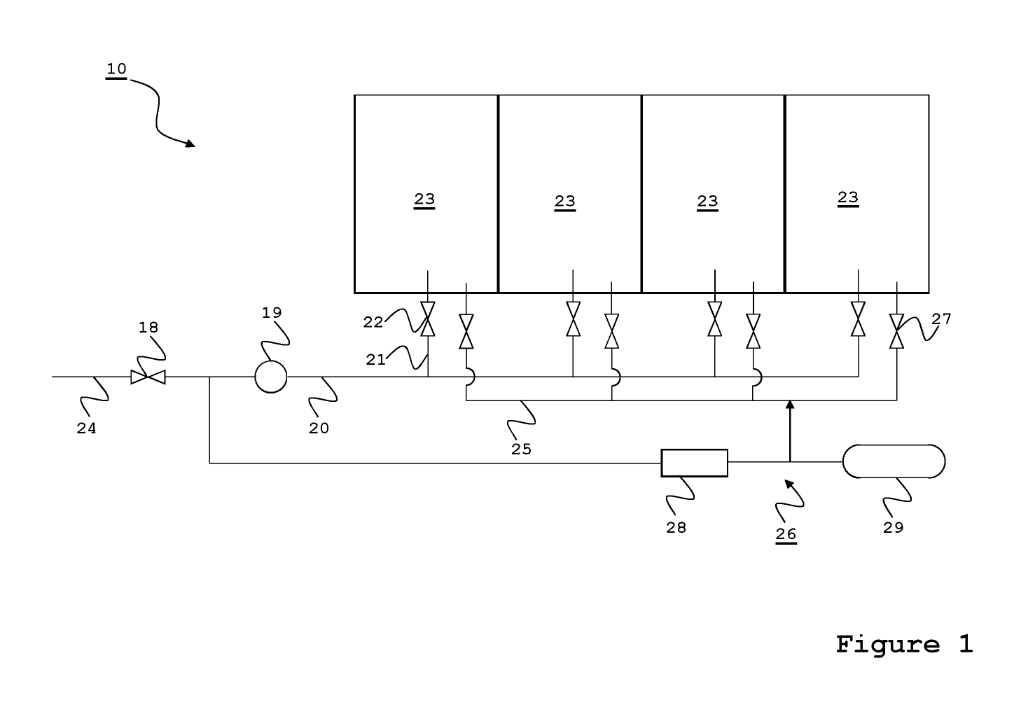

FIG. 1 illustrates a schematic diagram of one embodiment of the described invention, here referred to as the system 10. For the purpose of clarity, the schematic diagram has been simplified to communicate the main features of the system 10.

The system 10 may serve both to supply and to discharge ballast water to and from the ballast tanks 23.

In one embodiment of the invention, ballast water is pumped by ballast pump 19 from the ballast water inlet/outlet 24 and distributed to the ballast tanks 23 via the ballast water conduct 20, the supply tubes 21 and supply tube valves 22.

In this embodiment, one ballast tank 23 is left empty but the operator of the system may choose to leave any of the ballast tanks 23 empty and charge the remaining ballast tanks 23 with ballast water.

In another embodiment of the invention, ballast tanks 23 are charged with a volume of ballast water such that one ballast tank 23 may be emptied by distributing the ballast water to the remaining ballast tanks 23.

Once the ballast tanks 23 are charged by means of the ballast water pump 19, ballast water inlet/outlet 24 may be closed by inlet/outlet valve 18. Ballast water may then be pumped by ballast water pump 19 from a charged ballast tank 23 and enter the treatment system 26. The treatment system 26 may comprise a treatment unit 28 and a gas supply unit 29. Once the ballast water has passed the treatment system 26 it may be distributed to an empty ballast tank via the treatment manifold 25. The treatment manifold facilitates a number of manifold valves 27 which may be open or closed depending on which ballast tank 23 is to be charged.

The treatment unit 28 may be a pasteurising heat-treatment system or in principle any other system capable of treating ballast water e.g. a system comprising an ultra violet light radiation unit, a system based on vibration, sound, chemical treatment etc.

The gas supply unit 29 may comprise a nitrogen generator combined with or substituted by a carbon dioxide generator, and when, in the text above or below, reference is made to either nitrogen or carbon dioxide, it is not to be understood unequivocally since the one type of gas may replace the other.

In system 10 ballast water may be distributed either treated or untreated between two of the given ballast tanks 23. During distribution of ballast water between two ballast tanks 23, the treatment unit 28 may either be bypassed or it may be configured to allow fluid to pass without treatment and the gas supply unit 29 may be turned off.

One or more of the ballast tanks 23 may comprise injection nozzles (not shown) connected to the treatment manifold 25. The nozzle heads may comprise nozzles of the type fixed nozzles or nozzles configured for powered rotation about a first axis or nozzles configured for powered rotation about both a first and a second axis which is perpendicular or not perpendicular to the first axis to the effect that a two- or three-dimensional mixer pattern is formed, or a combination of nozzle heads with both one or more fixed nozzles and/or one or more rotating nozzles.

The system 10 may comprise recirculation systems (not shown) coupled to the same ballast tank 23. For instance, each row of nozzle heads may constitute a recirculation system, and thus each single minor recirculation system will further treat the ballast water from the preceding recirculation system which will thereby enhance the deoxidization in the front zone of the ballast water.

In the treatment of the ballast water and in order to optionally uphold an oxygen-poor or oxygen-free environment in the ballast water, nitrogen may be added to the ballast tanks 23 for periods of time or at fixed intervals, if necessary. The supply of nitrogen take place directly to the ballast water in the ballast tanks 23 via the treatment manifold 25 to which a nitrogen supply may be connected.

A periodic supply of nitrogen to the water in the ballast tank 23 may likewise ensure that atmospheric air containing oxygen does not penetrate into the ballast tank.

It should be understood that the ballast tanks 23 illustrated in FIG. 1 may be located e.g. on starboard side or portside or a combination of both and that there may be more than four ballast tanks 23 connected to the treatment system 26.

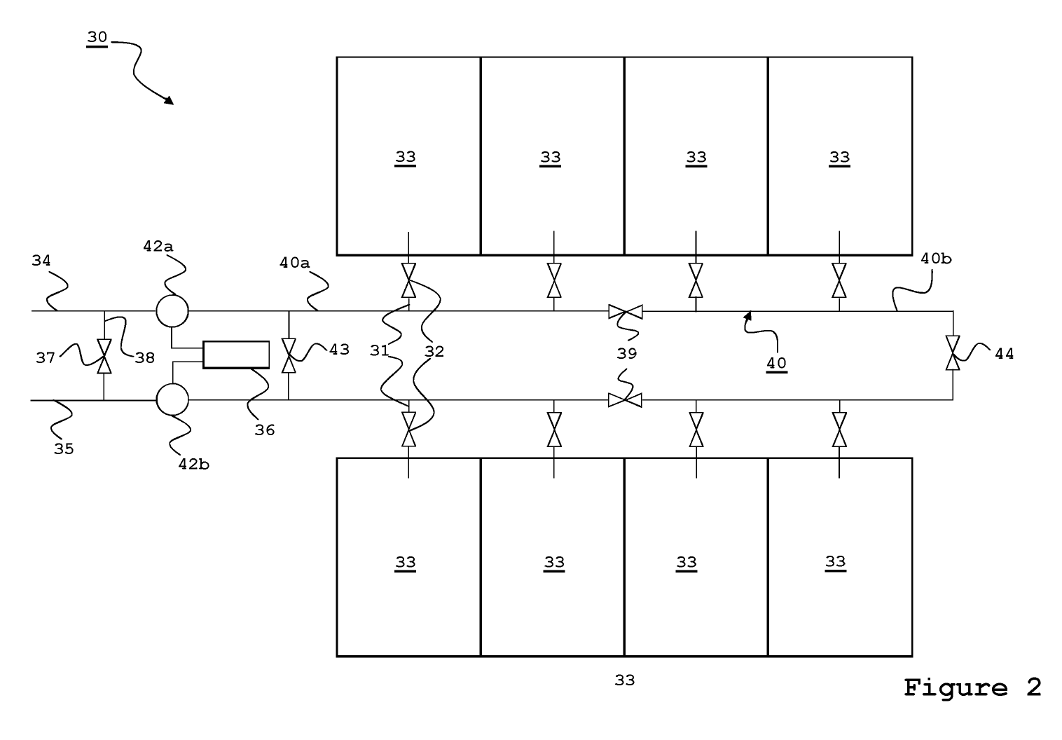

FIG. 2 illustrates a schematic diagram of one embodiment of the described invention, here referred to as system 30. For the purpose of clarity, the schematic diagram has been simplified to communicate the main features of said system.

System 30 comprises supply tubes 31, supply valves 32, ballast tanks 33, ballast water inlet/outlet 34, ballast water inlet/outlet 35, treatment system 36, circulation tube 38, circulation valve 37, ballast pump 42a & 42b, treatment valves 39 which divide the ballast water conduct 40 into two substrings 40a and 40b.

The treatment system 36 corresponds to the treatment system 26 and may comprise a pasteurising heat-treatment system or in principle any other system capable of treating ballast water e.g. a system comprising an ultra violet light radiation unit, a system based on vibration, sound, chemical treatment etc. and may also further comprise a gas supply unit corresponding to gas supply unit 29 described above.

However, test has shown that a pasteurising heat-treatment system is a very efficient system and test results also shows that a single treatment by a pasteurising heat-treatment system is enough to bring the contents of the organisms to a level which complies with the regulations set out by IMO (the International Maritime Organization—is the United Nations specialized agency with responsibility for the safety and security of shipping and the prevention of marine pollution by ships). This entails that untreated ballast water may be pumped from a ballast water tank and through heat treatment in the pasteurising heat-treatment system and thereafter discharged to sea. Such a single treatment cycle could even be performed before the ship enters port.

In system 30, ballast water may be charged from the sea to the ballast tanks 33 by activating ballast water pump 42a or 42b and configuring treatment valves 39 and supply valves 32 such that ballast water may be pumped from ballast water inlet/outlet 34 or ballast water inlet/outlet 35 to any given ballast tank 33.

In system 30, ballast water may be distributed between different ballast tanks 33 by activating ballast water pump 42a or 42b and configuring treatment valves 39 and supply valves 32 such that treated or untreated ballast water may be distributed from a ballast tank 33 which has been charged with ballast water and into an empty ballast tank.

In system 30, ballast water may be circulated clockwise or counter clockwise in the ballast water conduct 40 by means of ballast pump 42a and 42b.

In one embodiment, system 30 may comprise cross-over valves 43, 44.

In system 30, when configured with two treatment valves 39, ballast water may be distributed only between ballast tanks 33 that are not connected to a common substring. This is due to the placement of the treatment valves on the ballast water conduct 40.

System 30 comprises four substrings 40a, 40b and two treatment valves 39 but may comprise more than two treatment valves 39 located on the ballast water conduct 40 between ballast tanks 23. System 30 may also comprise more than eight ballast tanks 33 whereby additional treatment valves 39 may be located on the ballast water conduct 40 between ballast tanks 33.

In one embodiment, system 30 comprises an uneven number of ballast tanks 33 being located in starboard side, said ship further comprises at least one treatment valve 39 positioned on the ballast water conduct 40 in the starboard side, said treatment valve 39 being positioned on said ballast water conduct 40 such that it divide said ballast water conduct 40 into two substrings 40a, 40b located in starboard side, one substring being connected to one supply tube more than the other substring

In one embodiment, system 30 comprises an uneven number of ballast tanks 33 being located in port side, said ship further comprises at least one treatment valve 39 positioned on the ballast water conduct 40 in the port side, said treatment valve 39 being positioned on said ballast water conduct 40 such that it divide said ballast water conduct 40 into two substrings 40a, 40b located in port side, one substring being connected to one supply tube more than the other substring.

1. A method for treating ballast water in a ship comprising at least two ballast tanks comprising a first ballast tank and a second ballast tank and a system for treatment of ballast water, in which said ballast tanks are in fluid communication with each other such that ballast water can be pumped to each one of said ballast tanks and such that ballast water can be pumped between said ballast tanks either treated or untreated, the method comprising the following steps:
(a) pumping the ballast water, wherein at least the second ballast tank is left empty;
(b) pumping the ballast water via the system for treatment of ballast water from at least the first ballast tank comprising untreated ballast water to at least the second empty ballast tank;
(c) continuing pumping and treatment until at least the first ballast tank being pumped from is empty.

2. The method for treating ballast water in a ship according to claim 1, wherein the ballast water in step (a) is pumped onboard.

3. The method for treating ballast water in a ship according to claim 1, wherein the system for treatment of ballast water is a heat treatment.

4. The method for treating ballast water in a ship according to claim 1, wherein the
ballast water is pumped from at least the first ballast tank comprising untreated ballast water to at least the second empty ballast tank during gas injection into the ballast water.

5. The method for treating ballast water in a ship according to claim 1, wherein the system for treatment of ballast water is a heat treatment and wherein the ballast water is pumped from at least the first ballast tank comprising untreated ballast water to at least the second empty ballast tank during gas injection into the ballast water.

6. The method according to claim 1, wherein the method comprises the following successive steps: pumping the ballast water from each ballast tank with untreated ballast water to an empty ballast tank, until all ballast tanks have been emptied at least once.

7. The method according to claim 1, wherein the method further comprises pumping the treated ballast water in step (b) to an empty ballast tank wherein the treatment comprises gas injection or heat treatment of the ballast water.

8. The method according to any claim 4, wherein the method comprises injecting the gas into the ballast tank by at least one injection nozzle installed in one or several of the ballast tanks.

9. A method according to claim 5, wherein the method comprises the following step: filling of an empty ballast tank while treating.

10. A system for treatment of ballast water in a ship comprising at least two ballast tanks, at least one system for treatment of ballast water, at least one injection nozzle installed in at least one of said ballast tanks, said injection nozzle configured for treatment of ballast water, wherein said ballast tanks are in fluid communication with each other such that ballast water can be pumped to each one of said ballast tanks and ballast water can be pumped between said ballast tanks either treated or untreated.

11. A ship comprising a hul, a stern and a bow and a starboard and a port side said ship comprising:
at least three ballast tanks being located in starboard and/or port side, a ballast water pumping system capable of providing a bidirectional flow and connected to a ballast water conduct,
supply tubes having a closable supply valve which connects each ballast water tank to said ballast water conduct,
a closable ballast water inlet leading from a supply of sea water to said ballast water conduct,
a closable ballast water outlet leading from said ballast water conduct is configured for delivery of ballast water to the sea,
a system for treating ballast water connected to said ballast water conduct, said connection being configured such that ballast water can selectively be pumped from any one of said ballast water tanks through or by-passing said system for treating ballast water, said ballast conduct being equipped with water circulation tube having a closable circulation valve, said ballast water circulation tube being adapted for interconnection of said ballast water inlet with said ballast water outlet, said ballast water conduct being equipped with at least one closable treatment valve positioned between two supply tubes.

12. A ship according to claim 11 wherein said ship comprises at least four ballast tanks being located in starboard or port side, said ship further comprising at least one treatment valve being positioned on said ballast water conduct such that the at least one treatment valve divides said ballast water conduct into two substrings, and wherein each substring is in the side with at least four ballast water tanks and wherein each substring is connected to at least two supply tubes.

13. A ship according to claim 11, wherein said ship comprises at least four ballast tanks being located in both starboard and port side, and at least two treatment valves positioned on the ballast water conduct in starboard and port side respectively, and wherein each treatment valve is positioned on said ballast water conduct wherein the treatment valves divide said ballast water conduct into two substrings located in both starboard and portside and wherein each substring is connected to at least two supply tubes.

14. A ship according to claim 11, wherein said ship comprises an even number of ballast tanks, wherein said ballast tanks are located in starboard side, and wherein said ship further comprises at least one treatment valve positioned on the ballast water conduct in starboard side, and wherein said treatment valve is positioned on said ballast water conduct wherein the treatment valve divides said ballast water conduct into two substrings located in starboard side, and wherein each substring is connected to the same numbers of supply tubes.

15. A ship according to claim 11, wherein said ship comprises an even number of ballast tanks being located in port side, and wherein said ship further comprises at least one treatment valve positioned on the ballast water conduct in the port side, and wherein said treatment valve is positioned on said ballast water conduct wherein the treatment valve divides said ballast water conduct into two substrings located in port side and wherein each substring is connected to the same numbers of supply tubes.
